(19) United States
(12) Patent Application Publication
(10) Pub. No.: US 2004/0150217 A1
(43) Pub. Date: Aug. 5, 2004

(54) Identifying indicia and focusing target

(76) Inventors: David M. Heffelfinger, Sequim, WA (US); Gregory J. Fisher, Hayward, CA (US); Charles Stewart Smith III, Sacramento, CA (US); David M. Schneck, San Jose, CA (US)

Correspondence Address: SCHNECK & SCHNECK, P.O. BOX 2-E, SAN JOSE, CA, 95109-0005, US

(21) Appl. No.: 10/762,851

(22) Filed: Jan. 22, 2004

Related U.S. Application Data
(60) Provisional application No. 60/442,332, filed on Jan. 23, 2003.

(51) Int. Cl. G01N 21/00

(52) U.S. Cl. 283/81; 356/436

(57) ABSTRACT

A fluorescent identification and focusing target indicia and associated methods for use. The indicia is used to label a substrate, and may subsequently be used first as a target to focus the optical analysis and next as a specific identifier of the substrate and/or of reagents used with the substrate. The label may be a separate layer joined to the substrate by an adhesive. The indicia may include multiple dyes, a dye that produces fluorescence in a plurality of channels, a reflective component, a human interpretable component, a quantification means, a sizing standard, or other components.

### RELATED APPLICATION

The present invention claims priority from U.S. Provisional Patent Application No. 60/442,332, filed Jan. 23, 2003.

### FIELD OF THE INVENTION

The present invention relates to the optical analysis of targets and specifically to data identification and organization and optical system focusing.

### BACKGROUND OF THE INVENTION

Optical analysis of targets requires identifying a sample, focusing on the target of interest, and imaging the target of interest. Most commonly, each of these steps is a distinct and separate process.

Focusing

Before data is collected, an optical analysis system must be focused to ensure that the optics of the system detect from the focal plane containing the targeted samples. The imaging system must focus on a substrate plane where the samples are located (e.g. slide surface for slide arrays, etc.) There are a number of possible focusing methods. A number of systems rely on manual focus, whereby a user adjusts the optics until discrete targets are clearly imaged. In some systems, software retains a user-specified focus on a target for a specific sample substrate. Manual focusing is time consuming and in some cases error prone.

An alternative focusing means in present use is to use a portion of the substrate as a focus target. The optical elements or target substrate may be moved relative to the detector until the detection of the image is sharp. However, if the samples produce only weak fluorescence, the system may not focus well.

Furthermore, if the sample substrate is contaminated with non-specific fluorescence (as could be the case in homogenous assays) the autofocus may target an incorrect location, the location of fluorescence not associated with the sample.

Another focusing means is to use a reflective surface as a localized focusing target. U.S. Pat. No. 6,441,894 discloses the use of specular reflection from reflective targets to allow focusing onto a specific surface. The reflective surface may be the targeted surface or may have a known location in relation to the targeted surface, allowing refocusing onto the targeted surface. The reflective surface may include a pattern by which the specific location on the targeted surface is determined. In this system, the focusing requires illumination with one wavelength and detection of the same reflected wavelength. A dedicated focus detector is used. Subsequent detection of the sample requires separate optical elements that illuminate at a first excitation wavelength and detect at a second emission wavelength. Given that the emission wavelength is orders of magnitude (10⁶ to 10¹²) less bright than the excitation wavelength, an emission filter must be used to filter out the excitation light before it reaches light detectors used to measure fluorescence from a sample. If the excitation light were to reach the detectors, even as incidentally reflected light, the intense excitation light would overwhelm the relatively dim collected emitted light. The use of an emission filter allows separation of light of the excitation wavelength from light of the emitted light wavelength from reaching the detector. However this would preclude the use of reflected light detection by the emission detectors for either focusing or sample identification.

Identification of Samples

In addition to focusing on the sample, another required step for the analysis of a sample is organization of the generated data and correlation of data with a labware device (slide, well in a multiwell plate, gel, etc.) from which the data was generated. This requires some labeling of the labware device, labeling of the samples used with the labware device and labeling the resultant data as associated with both the labware device and the sample. The advances in high throughput analysis of samples has increased the challenges of tracking samples, labware and data.

One solution, as in focusing, is simply to manually correlate the samples, labware and data sets by recording in a notebook or on a spreadsheet data for each captured image or optical analysis of a labware device. This is labor intensive, prone to error, and difficult to implement for high throughput applications. In addition, if many individuals are involved in the process of data gathering, it is difficult to implement a uniform method of data tracking.

One alternative to automate sample detection is to utilize a machine-readable, reflection based indicia as a label on labware. One typical indicia is a bar code, as disclosed for use in labeling an array in U.S. Pat. No. 6,399,365. This patent discloses a package for a hybridization array having a substrate including an array of probes immobilized on a surfaces surrounded by a housing. On the housing may be a bar code or other labeling indicia. Such a bar code would be read by directing light of a selected wavelength at a machine-readable indicia (e.g. a bar code). Light of the same wavelength is reflected from a pattern of reflective locations. A scanner then detects the reflected light. Like reflective based focusing systems, this reflection based identification system requires separate optical components from the fluorescent detection components, where the excitation wavelength must be filtered from the detected emission wavelength.

Another reflection based identification system is disclosed in U.S. Pat. No. 6,215,894. It is a system for scanning biochip arrays which includes a unique image array identifier recorded for each array, and a computer-stored record corresponding to each identifier and containing the parameters of the experiment in the array identified by the identifier. The system further includes means for accessing a protocol library to retrieve the scanning protocols associated with the identified arrays and then scanning the arrays in accordance with the respective protocols. The resulting image maps generated by the scanners are stored in locations corresponding to the associated identifiers.

Imaging systems that require a separate reader to identify the labware introduce a chance of error in sample identification. Typically a reflective bar code is affixed to the labware and read by a separate bar code reader. Software would then combine the identification information with the sample data generated by the fluorescent imaging device. Operator or software error may attribute incorrect identification data to sample data. Since no material property of the identifying indicia is specific to the sample, such error is possible.

An alternative would be to use existing fluorescent imaging components to detect a identifying indicia on the sample. Such an identifying indicia could become part of the captured image or captured data.

It is an object of the invention to provide an identifying indicia on a sample substrate that is detectable by a fluorescence detection system. Such an identifying indicia would ideally be adaptable for other uses in analysis of the sample.

### SUMMARY OF THE INVENTION

The present invention uses fluorescent identification indicia to identify a sample substrate holding discrete fluorescent targets. In one embodiment, the fluorescent identification indicia are placed on a planar sample substrate in a defined spatial relation to the planar sample substrate surface (target focal plane). By identification of the focal plane of the fluorescent identification indicia and knowing the spatial relationship of the plane containing the fluorescent identification indicia to the targeted sample containing plane, the sample location and detection optics may be moved relative to each other to bring the sample substrate plane into focus. The fluorescent identification indicia and the discrete fluorescent targets have similar excitation and emission wavelengths. Using this means, a single set of emission and detection optics would be used for the identification of the identification indicia. The identification indicia would be localized both in relation to the plane containing the fluorescent targeted samples and would be at a specific location within the field of view or scanned area to allow for simplified targeting of the focusing/identification indicia.

In a second embodiment of the invention, a method of identifying a sample and focusing in a sample is disclosed. This method uses an identifying indicia at a specific location (either at a known distance from the sample holding plane or on the sample plane). The identifying indicia are specifically localized within the analyzed plane. The optical system uses this location to focus the system onto the plane including the targets. The plane is then analyzed (e.g. scanned or imaged) and the identifying indicia become part of the captured image, which is stored in a memory.

A third embodiment of the invention is a plurality of machine readable identifying indicia that are produced as transferable labels, at least one of which includes a fluorescent identifying indicia that has an excitation and emission wavelength that would allow detection of sample by the same optical analysis system as that used to analyze the sample. Two or more inks may be used to print the indicia. One of the inks is capable of being read by a standard barcode scanner, for example a high contrast black ink commonly used in bar code labels. The black ink is also human readable. A second ink is read by the fluorescent detector. The fluorescent ink preferably is printed on the adhesive side of the label, so as to be as close as possible to the targeted focal plane of the sample.

In another implementation of this embodiment, the fluorescent identifying indicia is created from the same dye as is used to detect fluorescent targets in the analyzed samples. In yet another implementation of this embodiment semi-transparent inks are used that fluoresce and the inks are printed on top of one another thus extending the number of useful dye channels that can be used with the label. At least one additional label in the plurality of machine-readable identifying indicia would include a reflective scanned bar code. Such a reflective scanned bar code could be read by present bar code scanners and printed out by available printers. The generated labels could be attached to sample source containers (e.g. multiwell plates, tubes, etc.) and/or laboratory notebooks or other records to allow for tracking of the source of samples along with the analytical data generated from those samples.

In any of the above embodiments, a number of implementations are possible. These include:

1. The use of bar codes as the identification indicia.

2. The use of bar codes as the identification indicia where the bar codes include a machine-readable and a human readable components.

3. The use of multiple fluorescent dyes in the identification indicia.

4. The use of an identification indicia that also includes dyes at various area densities to allow for quantification calibration.

5. The use of an identification indicia wherein elements of the identification indicia may act as sizing standards.

6. The use of an identification indicia wherein the identification indicia is placed to allow imaging orientation.

7. The use of multiple identification indicia on a single substrate to simplify image tiling.

### BRIEF DESCRIPTION OF THE DRAWINGS

FIG. 1 is an exploded side view of a cross section of a substrate, backing and a labeling layer.

FIG. 2 is a top view of a slide labeled with an identifying indicia.

FIG. 3 is a schematic of a bar code labeling system using both reflective identifying indicia and fluorescent identifying indicia.

FIG. 4 is a flow chart showing the use of the identifying indicia.

### BEST MODE FOR CARRYING OUT THE INVENTION

As used in the present application, fluorescent identification indicia is any machine or human interpretable localized mark that has sufficient information storage capacity to allow for specific identification of a sample substrate. A bar code imprinted with fluorescent dye would be one example of such a fluorescent identification indicia. A traditional bar code contains a number of parallel line segments arranged in a rectangular block. A line scan determines the pattern of reflective and nonreflective locations. The bottom of the bar code commonly includes an alphanumeric designation for the machine readable bar code. This allows a human user to input the alpha numeric designation if the line part of the code cannot be read. In the present application, a fluorescent bar code could vary from a conventional bar code. In a conventional bar code, the alternating reflective/nonreflective locations along the line scan provide a binary code for a reader. The use of fluorescence allows for a higher order of encoding schemes by allowing wavelength of emission or emission intensity to be used for information storage by the code (e.g. different intensity measurements could indicate different ID variables). In addition, a fluorescent bar code could use side-by-side dots instead of parallel lines in the code. The fluorescent bar codes could use lines or spots that are about the same size as the discrete targets detected by the analytical system used for viewing the sample. Such a code would take up minimal data storage space and require minimal materials to create while still providing a unique identity for the sample of interest.

The present invention uses fluorescent identification indicia for the specific labeling of targeted samples on a substrate. The fluorescent identification indicia may be used in a number of different ways to allow a number of different functions. For example, if the backing material is fluorescent, then the labeling material may be non-fluorescent allowing for a negative display of the identification indicia. In addition, non-fluorescent inks may be used to provide for scanning by standard barcode readers generally found in laboratory equipment.

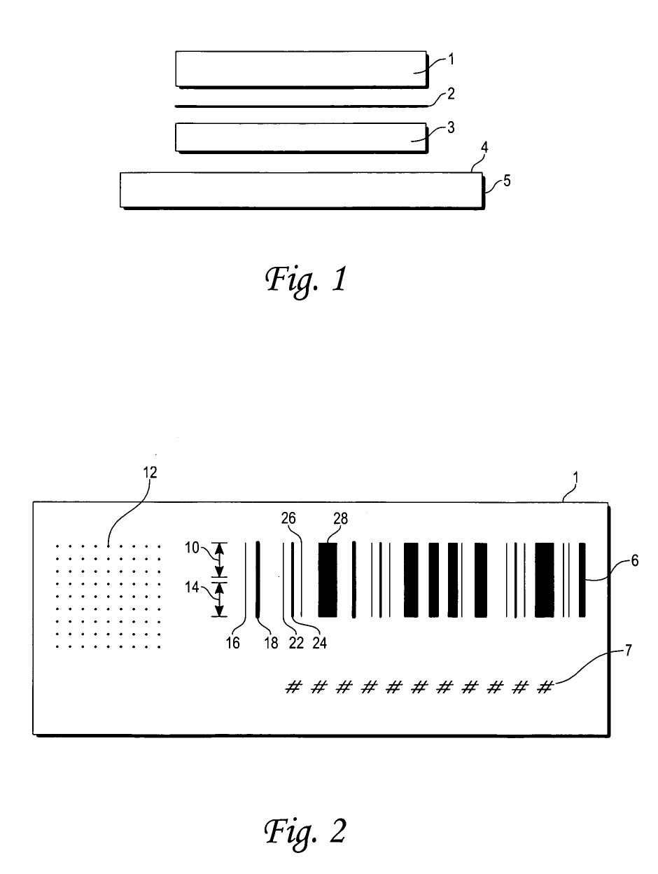

One advantage of the present fluorescent identification indicia is as a focusing target. With reference to FIG. 1, in one implementation of the present invention a substrate 5, such as a slide, multiwell plate bottom, microfluidic device or other substrate surface has a focal plane of interest 4. On a surface imaged by imaging focal plane 4 are discrete fluorescent targets, such as cells, array spots, separation channels or other targets. The fluorescent identification indicia could be placed on the imaged surface, at a specified location. Once the optical analysis system was focused on the fluorescent identifying indicia, an area of the imaged surface including the fluorescent identification indicia would be analyzed and the image data stored in a memory.

In the embodiment of FIG. 1, the fluorescent identification indicia are not on the imaged surface. Instead the fluorescent labeling material is on a backing material 1 in a separate layer of labeling material 2 attached by an adhesive 3 to the substrate 5. To provide a printing surface for the labeling material 2, a backing material is used. The backing material may be transparent or opaque, fluorescent or non-fluorescent depending on the intended use. If the backing material is transparent, then a transparent sample holder such as a glass slide may be imaged from either side. If the backing material is fluorescent then the labeling material may be non-fluorescent or absent altogether to form a negative of the indicia. Alternately, the backing material and the labeling material may both fluoresce but do so in different channels-thereby extending the number of useful dye channels that may be reliably used. Preferably, the adhesive material 3 has a thickness that is within the depth of field of the optical analysis system, thus allowing the indicia and sample targets to lie in the same focal layer. In one implementation, the fluorescent ink is one such as the ink sold by Cellotape (Fremont, Calif.) under the designation CES 102E8 warrant red, which it has been determined will fluoresce in the Cy₃™ (Amersham Biosciences, Piscataway, N.J.) dye channel (i.e., the detection channel that detects fluorescence at a wavelength of 568 nm) of target samples. This red ink will also fluoresce in several other dye channels commonly used in optical analysis systems. The label material is a polymer, for example a clear gloss polyester, such as the clear gloss polyester sold by 3M (St. Paul, Minn., as product #7831) with a thickness of 0.001±0.0005 inches. The ink is printed on the adhesive side of the label so as to be as close as possible to the target focal plane of the sample. For example, if the depth of field of the optical analysis system is 200 microns and the adhesive thickness is 20.0±12.5 microns, then the fluorescent target sample will be focused when the fluorescent indicia is focused. The adhesive used preferably can be applied with the above thickness specification. One such adhesive is sold by 3M (St. Paul, Minn.) as Type 400 adhesive. The label is designed to be applied to glass slides used in DNA microarrays and has dimensions of 1.0×0.5×0.0018 inches and the corners have a maximum radius of 1/16 inch. A human readable eight digit decimal number is also printed on the label with the red ink which corresponds to the bar code number. The bar code used encodes the V.C.C. code 128 standard and the top and bottom printed bar codes are printed in red and black ink respectively. Both bar codes contain the same number but in different inks. The adhesive used must withstand 1 hour of immersion in a detergent filled water bath at 70 degrees centigrade which are conditions typically encountered in the hybridization of DNA microarrays. On the surface of fluorescent labeling material 2 at a specific location on the planar surface is a fluorescent identification indicia. This location is used as a focus target for the optical analysis system. Once the system is focused on material 2, the system may then adjust the focus onto focal plane 4 by simply moving the focus the known thickness of material 2 and adhesive material 3. Alternatively (as noted above), the fluorescent focus target/identification indicia is printed on the underside of labeling material 2 such that the defined spatial relationship between labeling material 2 and focal plane 4 is that the focal target is within the depth of field of plane 4.

Focusing may be accomplished in any of a number of known ways. In one presently used focusing technique, the focal spot is moved along a z-axis as the detector measures the signal intensity from the illuminated spot. As the focal spot is moved into the focal plane, the detected emitted fluorescence will increase to a maximum, at which point the system will be in focus. An alternative focusing technique is to compare side-by-side pixels in a scan to determine the contrast from locations emitting and not emitting fluorescent signals again during z-axis movement. At the location of highest contrast, the system would be in focus.

Fluorescent identification indicia present a number of advantages when used for focusing. The amount of fluorescent dye for such a focusing target would be known and could be selected to provide a strong signal. The location of the focusing target in a two dimensional plane would be known. In addition, the identification indicia would provide sharp contrast locations between stripes containing fluorescent dyes and locations not containing the dyes.

A number of properties of the fluorescent identification indicia add functionality to these marks. First, the fluorescent identification indicia may use the same dye as will be used to detect discrete targets in the analyzed sample. Second, the fluorescent identification indicia may be composed of lines or dots that are the same size or same width as detectable targets in the sample. By inclusion of the fluorescent identification indicia in the same image as the sample data, the fluorescent identification indicia may be used as a size standard for comparison to data. Further the identification indicia may be used to orient the image, or stitch together multiple frames, each having one fluorescent identification indicia.

With reference to FIG. 2, a top view shows a location of one specific fluorescent identification indicia. In this view, a machine interpretable fluorescent labeling indicia 6 and human interpretable fluorescent indicia 7 are illustrated. The human interpretable indicia may additional also be machine readable (e.g. machine readable alpha numeric characters, as found in a UPC mark). In FIG. 2, the mark is quite large, about the size of standard product label bar codes. However, in practice the fluorescent identification indicia could be composed of bars, dots, or other discrete marks that are about the same size as the discrete targets to be analyzed. For example if the targeted samples are array spots 12, the width of each line could be 5-50 nanometers, depending on the size of the array spots. This fluorescent identification indicia would become part of an imaged area with out consuming an undue amount of the field of view of the image.

A number of features are possible for use with the present fluorescent identification indicia. These include:

1. Use of Multiple Dyes.

As shown in FIG. 2, the top half of a fluorescent bar code (height 10) can be printed in a first fluorescent dye and a bottom half of a fluorescent bar code (height 14) can be printed in a second fluorescent dye. In this way, the fluorescent identification indicia could be used for assays using two or more dyes. It is possible that these dyes are both excited by the same wavelength of excitation light and emit at wavelengths that are sufficiently similar that both dyes can be detected using the same emission filter to filter the collected emitted light. More commonly, a filter will be used to select a wavelength of the illumination light, to select the wavelength range of transmitted collected light, or both. This would require the system to optically analyze the focal surface twice, once using the first filter set, and once using the second filter set. The two images could be subsequently combined using software, and the fluorescent identification indicia compared to ensure that the combination is both combining the correct images and that the combination has properly localized these images.

2. Sizing of Targets

As previously noted, the size of the bars, spots, or other discretely sized components of the fluorescent identification indicia could have a size matched to the size of the target to be analyzed. The fluorescent identification indicia thus are a small part of the imaged or analyzed area. In addition, the size of the discrete components that comprise the fluorescent identification indicia may be used as a sizing standard. For example, if the analyzed targets are cells of a size range then the discrete components of the fluorescent indicia can be compared to detected targets if the discrete components have a size that falls in the expected range of the targets. Analytical software could compare the sizes of the detected targets and the fluorescent identification indicia components.

3. Normalization of Data

Another function often required in analyzing data sets is comparing data from analysis of different samples analyzed at different times. However a number of difficulties can occur that make such comparison difficult. For example, on different days instrumentation could analyze samples slightly differently because of subtle changes to the analytical system. It is also possible that differences in the materials of the sample could result in variable emissions from similar samples. The use of the fluorescent identification indicia could also provide a standard for comparison of samples, and attendant adjustment of data to allow direct comparison of samples from separate sample analysis events.

4. Quantification.

Quantification is also useful in analyzing samples. In assays using binding agents, if the binding agent is labeled with a known quantity of a fluorescent labeling agent, the intensity of detected fluorescent signals would correlate with the amount of detected target on the sample. One simple means to create such a static quantification standard (e.g. a quantification bar code, which could be used for focusing, sample identification, and creation of a quantification table) would be to use presently available quantification products. For example, flow cytometry quantification calibration beads include several (4 or more) containers, each container including standardized sized polymeric beads coated with a dye at a specific surface dye amount in each container. In a flow cytometer, the beads are separately analyzed, the resultant detected fluorescent intensity plotted for each bead set on a log graph, and subsequent detection events plotted on this graph to quantify the amount of label on each discrete target detected. Such quantification beads could be used for the creation of a quantification bar code by simply affixing the beads (by adhesive, covalent bonding, use of a binding agent, or other known means) in a pattern to form a quantification bar code. In FIG. 2, line segments 16, 18, 22, 24, 26, 28 may each be comprised of beads having a surface dye at a specific surface amount. By measuring and plotting the detected intensity from each of the line segments, a quantification graph may be generated and subsequent data may be analyzed. While using commercially available beads affixed to a surface is one means of generating a quantification bar code, a number of other means are also possible, including direct binding of a dye to a material surface at a specific density.

One advantage of the use of reflective bar codes is such codes provide a standardized means for labeling of products or samples. The readers and software for generating and reading such codes are relatively inexpensive and commercially available. However for specific identification a sample on a substrate, the code has a number of drawbacks, including the requirement that two separate optical systems would need to be used for detection of fluorescence and detection of a reflective code. In addition, the reflective code would not be part of the detected fluorescent image.

With the present invention a set of labels could be created. At least one of the labels would be a fluorescent identification indicia placed on a substrate to by analyzed and becoming part of the stored image or data set. This label could be printed on a transparent material to be placed onto a substrate by an adhesive or other means. Alternatively, the label could be printed directly onto a sample holding substrate. In addition, one or more reflective identification indicia labels could be generated. Preferably, the reflective identification indicia labels could be printed on the same layer as the fluorescent indicia. This can be achieved by known lithography printing techniques wherein a first run prints one ink or dye on the backing material and a second run prints another ink or dye. In this way, several runs may be made to further extend the number of useful dye channels that may be used with the label. These labels could be affixed to laboratory notebooks, printed onto data sheets, affixed onto a sample container, or otherwise used to track the locations of regents, samples, labware, or records associated with the fluorescent label. The fluorescent label could be sized to allow the fluorescent mark to become part of the image. In contrast, the reflective labels would be larger, and could be the size of a typical product labeling bar code.

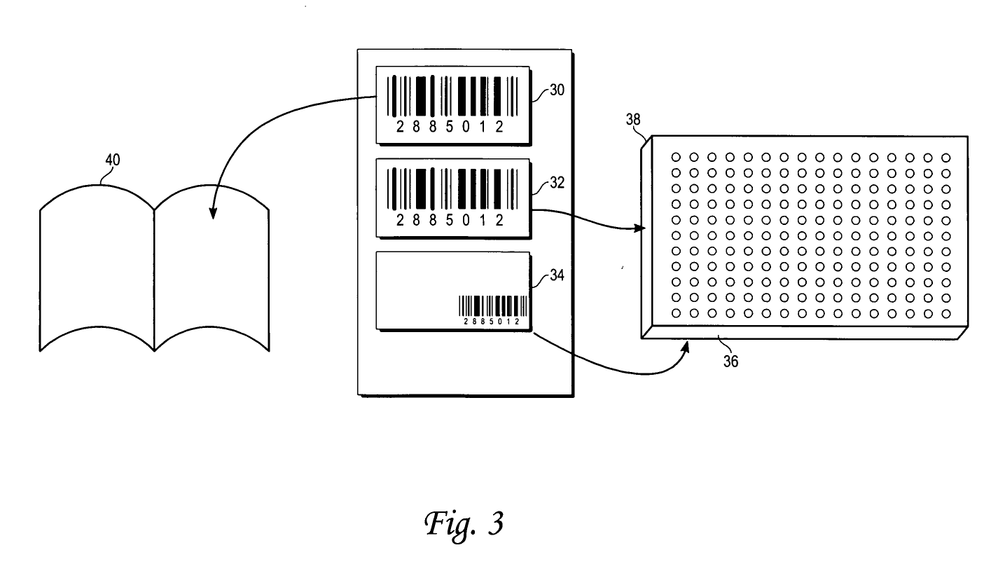

FIG. 3 illustrates the use of such a combination of reflective and fluorescent identification indicia. Reflective labels 30, 32 may be generated by a standard printer and affixed to a notebook 40 and a side of a multiwell plate 38 respectively. Subsequent scanning by a bar code scanner allows correlation of the plate and notebook entries to the saved fluorescent image data. Fluorescent label 34 would be affixed to the bottom surface face 36 of the plate, parallel to the focal plane of interest.

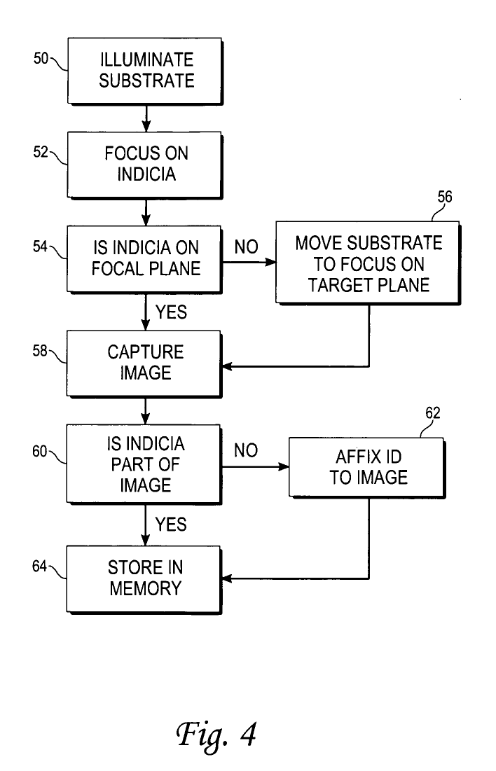

In FIG. 4, a flow chart of the function of the present system is illustrated. In the initial step 50, the sample substrate is illuminated. This may be either illumination of an entire imaged field or a spot within the field, depending on the analytical system. The detectors would then target the location of the fluorescent identification indicia. In step 52, the system would then focus onto the fluorescent indicia, which functions as a fluorescent target for focusing. In step 54 the system queries whether the fluorescent labeling indicia is on the focal plane of interest. This could be determined by a user input. Alternatively, the initial bits or character in the fluorescent identification indicia could indicate whether the label was on the focal plane. If the focus target was on the focal plane, the system would proceed to step 58. If the focus targets were not on the focal plane, the system would complete step 56 and move sample holding substrate a set distance such that the system is focused on the focal plane of interest. Again this distance could be manually encoded or encoded in the information contained in the fluorescent indicia.

Once the analytical system was focused on the focal plane of interest, the image would be captured in step 58. This could be done by a scan or by an imaging of an area. Next in step 60 the system would query if the fluorescent identification indicia was part of the image. If yes, the system would proceed to step 64 and the image would be stored in a memory. If no, the identification data would be attached to the image in step 62. The system would then proceed to step 64 and store the labeled image data.

The fluorescent identification indicia should have sufficient data storage capacity to provide vital information about the sample scanned. This could include:

1. The dye or dyes used.

2. The type of assay.

3. Identification of the sample being assayed.

4. Information about the location of the identification indicia (e.g. whether the indicia is on the targeted focal plane).

5. The distance required to move the focus for the focus to be on the sample plane. (i.e. the distance from the indicia plane to the focal plane holding the samples.

6. Parity data.

In present codes such as bar codes, two bars and two reflective spacers would be used to designate a number. In a fluorescent bar code or other identification indicia, wavelength and intensity could be used to create a higher order encoding scheme.

1. A labware device comprising:
a substrate having a planar surface that acts as a focal plane at which localized optically detectable targets are located; and
a fluorescent labeling material layer joined onto said substrate in defined spatial relation to said planar surface, said labeling material layer including an identification indicia pattern, wherein said optically detectable targets and identification indicia pattern have overlapping excitation and emission wavelengths.

2. The device of claim 1, wherein said substrate is a slide.

3. The device of claim 1, wherein said substrate is a microfluidic device.

4. The device of claim 1, wherein said substrate is a multiwell plate.

5. The device of claim 1 further comprising a backing material layer such that said fluorescent labeling material is located between said backing material layer and said substrate.

6. The device of claim 1 further comprising a backing material layer such that said backing material layer is located between said fluorescent labeling material layer and said substrate.

7. The device of claim 1, wherein said identification indicia pattern includes a human interpretable mark.

8. The device of claim 1, wherein said identification indicia pattern includes at least two different fluorescent dyes located at different locations on said indicia pattern.

9. The device of claim 8, wherein each of said at least two different fluorescent dyes has a different illumination wavelength.

10. The device of claim 1, wherein said identification indicia pattern is a bar code.

11. The device of claim 10, wherein said bar code is a quanitification bar code.

12. The device of claim 10, wherein said bar code includes a sizing standard.

13. A method of optical analysis of a substrate comprising:
illuminating using an optical system a planar surface of a substrate at a identifying indicia location;
focusing said optical system on a focal plane of said planar surface by using said identifying indicia as a focus target;
optically analyzing discrete samples on said target plane, wherein a resulting image includes both target sample data and identifying indicia data as part of an image; and
storing said resulting image in a memory.

14. The method of claim 13, further including changing an emission filter and repeating steps c and d for that filter.

15. The method of claim 13 further including providing on said identifying indicia a quantifying standard, generating a quantifying graph by analyzing said quantifying standard and analyzing collected data using said graph.

16. The method of claim 13 further including providing on said identifying indicia a sizing standard and analyzing collected data using said sizing standard.

17. An adhesive label for labware including:
a reflective bar code; and
a fluorescent bar code.

18. The adhesive label of claim 17, further including alpha numeric characters.

19. The adhesive label of claim 17, wherein said label is made from a clear polymer.

20. The adhesive label of claim 17, wherein the fluorescent bar code produces fluorescence in a plurality of detection channels.

21. The adhesive label of claim 17, further including a plurality of additional reflective bar code labels with identical codes as the adhesive label of claim 17.
